(19) United States
(12) Patent Application Publication
(10) Pub. No.: US 2014/0373044 A1
(43) Pub. Date: Dec. 18, 2014

(54) AUTOMATIC PARAMETRIC CONTROL OF AUDIO PROCESSING VIA AUTOMATION EVENTS

(71) Applicants: Timothy J. CARROLL, Lancaster, PA (US); Michael L. RICHARDSON, Reading, PA (US); Linear Acoustic, Inc., Lancaster, PA (US)

(72) Inventors: Timothy J. Carrol, Lancaster, PA (US); Michael L. Richardson, Reading, PA (US)

(73) Assignee: Linear Acoustic, Inc., Lancaster, PA (US)

(21) Appl. No.: 14/375,905

(22) PCT Filed: Feb. 27, 2012
(86) PCT No.: PCT/US12/26709

§ 371 Date: Jul. 31, 2014

(51) Int. Cl. H04N 21/439; H04N 21/81; H04N 5/60

(52) U.S. Cl. CPC H04N 21/439; H04N 5/60; H04N 21/812
USPC 725/32

(57) ABSTRACT

A system for automatic control of audio processing based on at least one of playout automation information and broadcast traffic information includes a receiver configured to receive an electronic signal including scheduling data representing at least one of playout automation information and broadcast traffic information including at least timing and content type information of content, and a content logic configured to determine audio parameters for the processing of audio associated with the content based on the scheduling data.

### FIELD OF THE INVENTION

The present disclosure relates to audio processing. More particularly, the present disclosure relates to methods and systems for automatic control of audio processing based on at least one of playout automation information and broadcast traffic information.

### BACKGROUND

Broadcasting facilities often use audio processing to alter characteristics of audio. Audio processing operations include changing level or dynamic range of the audio in order to affect the loudness level perceived by listeners. Other audio processing functions include upmixing or downmixing (e.g., the process of converting between stereo format and surround sound format) and certain intelligibility actions such as crowd noise reduction and increasing speech intelligibility. These processing functions are associated with audio parameters that affect the characteristics of the processed audio. Different content types often call for different audio parameters.

In one example, a classical music concert and a live sporting event may require different audio parameters in order to optimize the listener's audio experience. However, in a typical broadcasting facility audio parameters may remain preset to static values even while switching from one content type to another. The audio parameters may be set to levels that are optimal for one content type but not the other. Often the audio parameters are set to tradeoff levels that are not optimal for any content type, but that represent a compromise between optimal audio parameters for different content types.

Some broadcasting facilities may attempt to match audio parameters with content type. For example, the broadcasting facility may process audio corresponding to the classical music concert and the live sporting event differently. However, the broadcasting facility conventionally effects the change in the audio parameters for the different content types by relatively unsophisticated techniques involving the switching between two sets of static values.

In another example, program content such as television programs is, in many cases, produced with variable loudness and wide dynamic range to convey emotion or a level of excitement in a given scene. A movie may include a scene with the subtle chirping of a cricket and another scene with the blasting sound of shooting cannons. Advertising content such as commercial advertisements, on the other hand, is very often intended to convey a coherent message, and is, thus, often produced at a constant loudness, narrow dynamic range, or both. In many cases, annoying disturbances occur at the point of transition between programming content and advertising content. This is commonly known as the “loud commercial problem.”

Some broadcasting facilities may attempt to alter audio parameters of the program content or the advertising content to alleviate the “loud commercial problem.” For example, the broadcasting facility may process audio corresponding to the program content or the advertising content differently to reduce the perceived loudness of the advertising content or increase the perceived loudness of the program content, or both. However, the broadcasting facility conventionally effects the change in the audio parameters for the different content types by relatively unsophisticated techniques involving the switching between two sets of static values that affect loudness for whole segments of content, even portions that do not require processing, hence producing less than optimal audio for the program content, the advertising content, or both.

### SUMMARY OF THE INVENTION

A system for automatic control of audio processing based on at least one of playout automation information and broadcast traffic information includes a receiver configured to receive an electronic signal including scheduling data representing at least one of playout automation information and broadcast traffic information including at least timing and content type information of content, and a content logic configured to determine audio parameters for the processing of audio associated with the content based on the scheduling data.

A method for automatic control of audio processing based on at least one of playout automation information and broadcast traffic information includes receiving an electronic signal including scheduling data representing at least one of playout automation information and broadcast traffic information including at least timing and content type information of content, and determining audio parameters for the processing of audio associated with the content based on the scheduling data.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a simplified block diagram of an exemplary workflow of a broadcasting facility.

FIG. 2 illustrates a block diagram of an exemplary audio processing control system, which automatically controls audio processing based on playout automation information or broadcast traffic information.

FIG. 3 illustrates example broadcast traffic information.

FIG. 4 illustrates example playout automation information.

FIG. 5 illustrates a flow diagram of an example method for automatic control of audio processing based on playout automation information or broadcast traffic information.

### DETAILED DESCRIPTION

Broadcasting facilities often use traffic and automation systems to control and operate broadcasting equipment. These systems can control station playout, sending program content to air, inserting commercials, and even automatically billing the buyers of advertising time once their spots are played out. These systems often produce scheduling data that contains specific information about transitions and timing of those transitions as well as information that describes the type of content that is present at any given moment.

The present disclosure describes systems and methods for dynamically and automatically altering audio processing parameters based on this scheduling data. Based on the scheduling data, content segments may automatically receive audio processing specifically tailored to that content type. Further, because specific audio parameters can be dynamically changed based upon the scheduling data, content segments may dynamically receive audio processing specifically tailored to specific portions of content. Issues such as the “loud commercial” problem may be solved.

Although the present disclosure describes various embodiments in the context of the “loud commercial problem,” it will be appreciated that the exemplary context of the “loud commercial problem” is only one of many potential applications in which aspects of the disclosed systems and methods may be used. Therefore, the techniques described in this disclosure are applicable to other applications where processing of audio is required or desired such as, for example, downmixing or upmixing (converting between stereo and surround sound formats), noise reduction, increasing speech intelligibility, and so on.

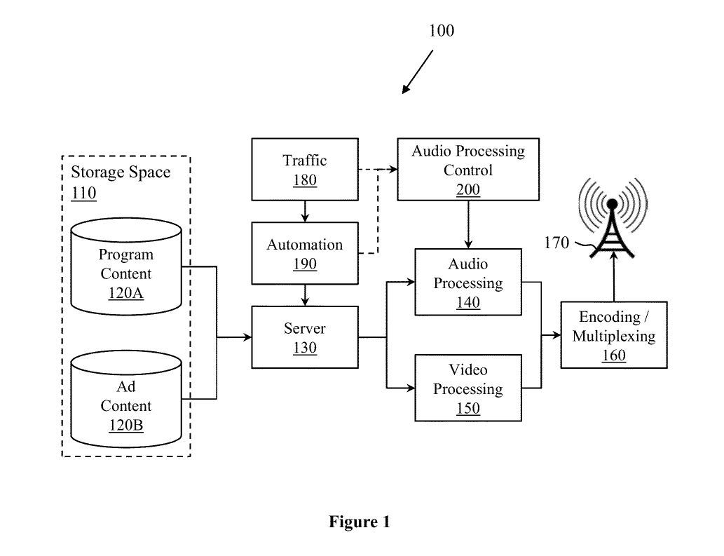

FIG. 1 illustrates a simplified block diagram of a workflow 100 for a broadcasting facility. The workflow 100 includes storage space 110. The storage space 110 includes program content 120A and advertising content 120B. In addition, the storage space 110 may include content other than program content 120A and advertising content 120B (e.g. on-screen graphics, pauses, interstitial material, etc.) Storage space 110 may take the form of, for example, hard drives, tapes, and so on. In one embodiment, the storage space 110 is local to the broadcasting facility. In another embodiment, the storage space 110 is remote to the broadcasting facility. In yet another embodiment, the storage space 110 includes portions that are local and portions that are remote to the broadcasting facility.

The storage space 110 operatively connects to components (not shown) that allow for the ingest of content from sources such as satellite networks, cable networks, fiber networks, and so on. The broadcasting facility may have an ingest schedule to ingest content from the sources for storage in storage space 110. The ingest process may also involve moving material from deep storage such as tape archives or FTP clusters to storage space 110. Although the program content 120A and the ad content 120B are illustrated as storage, in one embodiment, the program content 120A or the ad content 120B is received and ingested live for live broadcasting.

The workflow 100 further includes a server 130. The server 130 receives content from program content 120A and ad content 120B and integrates the program content 120A and the ad content 120B into a playout stream based on a playlist or scheduling data.

The workflow 100 further includes an audio processor 140 and a video processor 150, which process audio and video, respectively, of the playout stream as needed. Video processing involves altering characteristics of the playout stream's video, and may include adding graphics, subtitles, etc. to the stream. Audio processing involves altering characteristics of the playout stream's audio, and may include changing level or dynamic range to affect loudness, downmixing or upmixing (i.e., converting between stereo and surround sound formats), noise reduction, increasing speech intelligibility, and so on.

The workflow 100 further includes an encoder/multiplexer 160 where the playout stream is encoded or multiplexed as needed before transmission. The workflow 100 also includes a transmitter 170, which transmits the playout stream. Although transmitter 170 is illustrated as an antenna, implying wireless transmission, the transmitter 170 may be a transmitter or a combination of transmitters other than wireless transmitters (e.g., satellite, microwave, fiber, terrestrial, mobile, internet protocol television (IPTV), cable, internet streaming, and so on).

The workflow 100 further includes a traffic control 180. Traffic is generally understood as the preparation of a schedule from the business side of the broadcasting facility. The traffic control 180 may be used to create scheduling data indicating segments of the program content 120A, the ad content 120B, or any other content to be aired during a time period. The traffic control 180 transmits broadcast traffic information, which includes a listing of segments of content and the time at which each segment is to air. In addition, traffic control 180 may generate logs detailing when content, particularly ad content 120B, is planned to be aired and when the content is actually aired. The logs may be used in billing buyers of commercial time once advertising content 120B has been aired.

The workflow 100 further includes an automation control 190, which is used to automate broadcast operations. The automation control 190 controls or operates equipment in or outside the broadcast facility with very little, if any, human intervention. Among other functions, the automation control 190 may control station playout and the sending of content to air. The automation control 190 receives scheduling information and transmits playout automation information to control or operate equipment. In one embodiment, the automation control 190 receives a schedule from the traffic control 180. In another embodiment, the automation control 190 receives a schedule from a source other than the traffic control 180. In yet another embodiment, a user enters a schedule directly into the automation control 190.

The automation control 190 operatively connects to the server 130 and may control the server 130 to integrate the program content 120A and the ad content 120B into the playout stream. The automation control 190 may also at least partially control other equipment including the audio processor 140, the video processor 150, the encoder/multiplexer 160, and the transmitter 170.

The workflow 100 further includes audio processing control 200. In one embodiment, the audio processing control 200 operatively connects to the traffic control 180 to receive scheduling data in the form of broadcast traffic information from the traffic control 180. In another embodiment, the audio processing control 200 operatively connects to the automation control 190 to receive scheduling data in the form of playout automation information from the automation control 190. In yet another embodiment, the audio processing control 200 operatively connects to both the traffic control 180 and to the automation control 190 to receive scheduling data in the form of broadcast traffic information from the traffic control 180 or playout automation information from the automation control 190.

The audio processing control 200 operatively connects to the audio processor 140 and, at least partially, controls the audio processor 140. Based on the received scheduling data, the audio processing control 200 determines and transmits to the audio processor 140 audio parameters for the processing of audio. In one embodiment, the audio processing control 200 resides with the audio processor 140. In another embodiment, the audio processing control 200 resides separately from the audio processor 140.

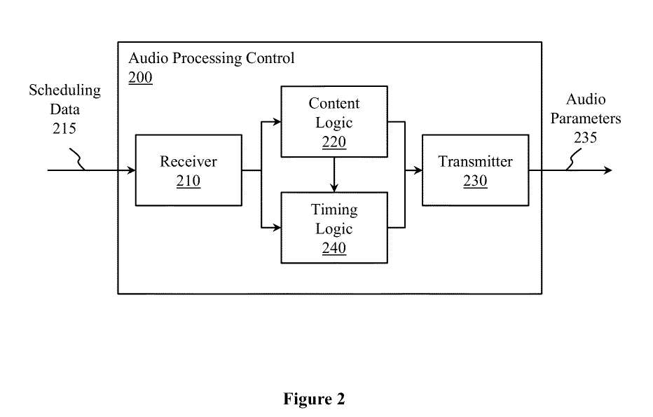

FIG. 2 illustrates a block diagram of an exemplary audio processing control 200, which automatically controls audio processing based on playout automation information or broadcast traffic information. The audio processing control 200 includes a receiver 210. The receiver 210 receives scheduling data 215 including playout automation information or broadcast traffic information. The scheduling data 215 includes timing and content type information of the content to be played out.

The receiver 210 receives an electronic signal including the scheduling data associated with a particular segment of content prior to airing of the segment. In one embodiment, the receiver 210 receives the scheduling data associated with the particular segment of content 30 seconds prior to airing of the segment. In another embodiment, the receiver 210 receives the scheduling data associated with the particular segment of content five minutes prior to airing of the segment. In one embodiment, the receiver 210 receives the scheduling data associated with the particular segment of content 30 minutes prior to airing of the segment. In other embodiments, the receiver 210 receives the scheduling data associated with the particular segment of content substantially prior to airing of the segment at times others 30 seconds, 5 minutes, or 30 minutes prior to airing of the segment.

In one embodiment, the audio processing control 200 sets the timing for the receipt of the scheduling data 215 by requesting the scheduling data 215. In another embodiment, the audio processing control 200 receives the scheduling data 215 on a schedule set by the traffic control, the automation control, or some other entity or combination of entities within or outside the workflow.

The audio processing control 200 further includes a content logic 220 that determines audio parameters for the processing of audio associated with content based at least in part on the timing and the content type indicated in the scheduling data 215. The content logic 220 obtains the timing and the content types of particular content segments from the scheduling data 215. Based on the timing and the content types, the content logic 220 determines audio parameters to transmit to an audio processor for the audio processor to process the audio associated with the particular content segments accordingly.

In one embodiment, the content logic 220 progressively determines audio parameters such that as a program content/advertising content transition approaches, the audio processor progressively adjusts the audio to change the peak to average ratio of the program content's audio before the transition. The content logic 220 may then progressively changed the audio parameters after the transition until the peak to average ratio of the advertising content's audio reaches either its original state or a state tailored specifically for advertising content.

In another embodiment, the opposite occurs, as the advertising content/program content transition approaches, the content logic 220 progressively adjusts the audio parameters to change the peak to average ratio of the advertising content's audio before the transition. The content logic 220 may then progressively change the audio parameters after the transition until the peak to average ratio of the program content reaches either its original state or a state tailored specifically for program content.

By, in essence, “looking ahead” to the program content/advertising content transition and determining appropriate audio parameters to automatically and dynamically process the program content or the advertising content, the content logic 220 helps solve or alleviate the “loud commercial problem.” The result is audio that transitions smoothly and is consistent through the transition.

In one embodiment, the audio processing control 200 applies audio processing specifically targeted to each content segment or content transition condition. In one embodiment, the content logic 220 determines dynamic range only for portions of content scheduled to air immediately before or immediately after a transition from programming content to advertising content or from advertising content to programming content. In one embodiment, audio processing is dynamically applied only to that segment or portion of a segment where processing is necessary. In one embodiment, the audio processing control 200 dynamically applies the audio processing required by a content segment or content transition. The result would be audio that is smooth and consistent through the transition with minimal or optimal processing.

In the illustrated embodiment, the audio processing control 200 further includes a transmitter 230 that transmits the determined audio parameters 235 to an audio processor for the audio processor to alter the audio associated with the content based on the audio parameters.

In the illustrated embodiment, the audio processing control 200 further includes a timing logic 240 that determines a time for the audio processor to process the audio according to the audio parameters 235. In one embodiment, the timing logic 240 determines a time for the transmitter 230 to transmit the determined audio parameters 235 to the audio processor such that the audio processor alters the audio associated with the content at the specified time. In another embodiment, the timing logic 240 determines a time to be transmitted by the transmitter 230 to the audio processor in addition to the audio parameters such that the audio processor alters the audio associated with the content at the specified time.

In one embodiment, the timing logic 240 determines the time for the audio processor to process the audio such that the audio processor alters the audio associated with a content segment prior to a time when the content segment is to air. In one embodiment, the altered audio may be stored for airing at a later time. In another embodiment, the timing logic 240 determines the time for the audio processor to process the audio such that the audio processor alters the audio associated with a content segment substantially in real time as the content segment is airing or just about to air. Thus the audio processing control 200 may control the audio processor such that the audio processor alters the audio substantially prior to airing, just prior to airing, or substantially live at air time.

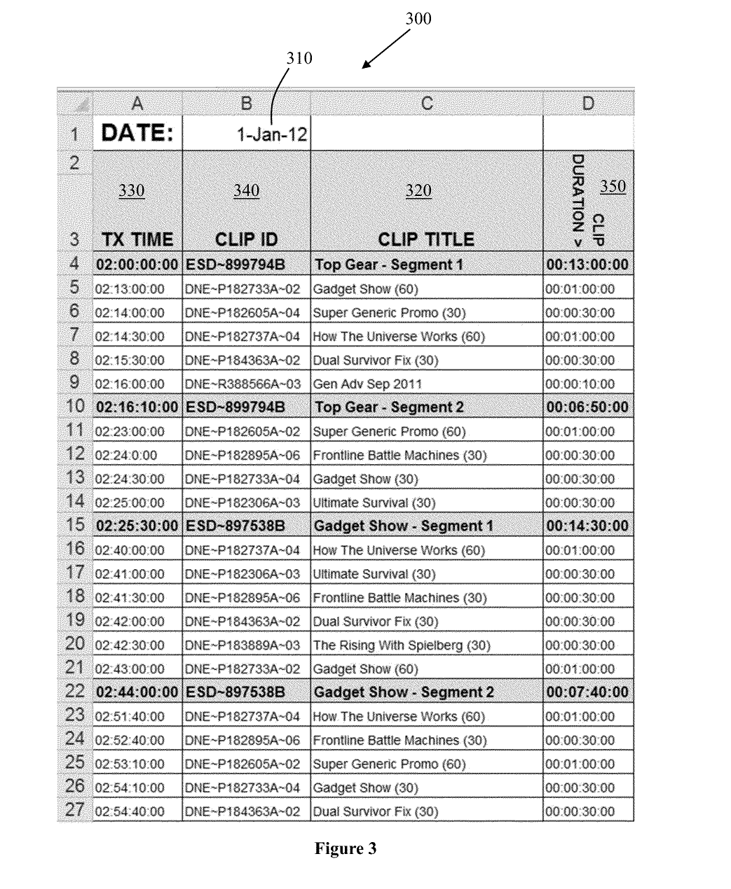

FIG. 3 illustrates example broadcast traffic information 300. As discussed above, the broadcast traffic information 300 includes timing and content type information of content.

The broadcast traffic information 300 includes the date 310 on which the content is to be aired. The broadcast traffic information 300 further includes a clip title column 320, which includes the title of the particular content segment. The broadcast traffic information 300 further includes a time column 330 which lists the time at which the content segment is to air. In the illustrated embodiment, the clip titled “Top Gear—Segment 1” is to air at 2:00:00 and the clip titled “Gadget Show (60)” is to air at 2:13:00.

The broadcast traffic information 300 further includes a clip ID column 340 that includes segment identifying information. The clip ID column 340 may include information that identifies a segment as program content, as advertising content, or some other type of content. For example, in the illustrated embodiment, the prefix ESD indicates that the segment titled “Top Gear—Segment 1” is program content and the prefix DNE indicates that the segment titled “Gadget Show (60)” is advertising content. The clip ID column 340 may also include other identifying information that may have meaning to the broadcasting company, advertisers, equipment, etc. The broadcast traffic information 300 further includes a clip duration column 350, which indicates the time duration of a content segment. In the illustrated embodiment, the clip titled “Top Gear—Segment 1” has a duration of 13 minutes and the clip titled “Gadget Show (60)” has a duration of one minute.

In the illustrated embodiment, the broadcast traffic information 300 is formatted as a spreadsheet. In other embodiments, the broadcast traffic information 300 is formatted as formats other than a spreadsheet such as industry standard formats and protocols as well as ad-hoc formats and protocols. In one embodiment, the broadcast traffic information is expanded with additional columns or fields to add information to the broadcast traffic information to be used in determining audio parameters for more specific altering of audio characteristics of content.

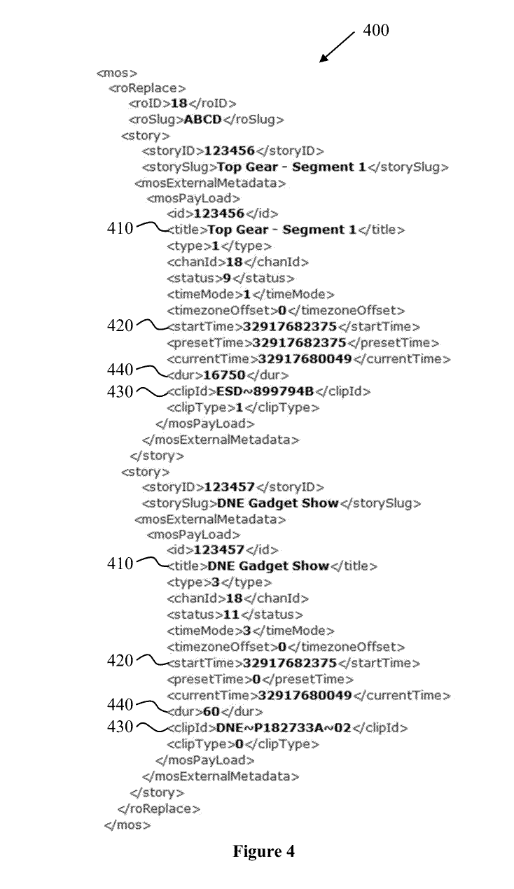

FIG. 4 illustrates example playout automation information 400. As discussed above, the playout automation information 400 includes timing and content type information of content.

The playout automation information 400 includes a segment title field 410, which includes the title of the particular content segment. The playout automation information 400 further includes a start time field 420 indicating the time at which the content is to be aired. The time may be expressed in absolute terms (i.e., date and time) or in relative terms (i.e., time from the current time). In the illustrated embodiment, the clip titled “Top Gear—Segment 1” is to air at a start time corresponding to 32917682375 units of time from a reference time and the clip titled “DNE Gadget Show” is to air at a start time corresponding to 329117682375 units of time from a reference time.

The playout automation information 400 further includes a clip ID field 430 that includes segment identifying information. The clip ID field 430 may include information that identifies the segment as program content, as advertising content, or some other type of content. For example, in the illustrated embodiment, the prefix ESD indicates that the segment titled “Top Gear—Segment 1” is program content and the prefix DNE indicates that the segment titled “DNE Gadget Show” is advertising content. The clip ID may also include other identifying information that may have meaning to the broadcasting company, advertisers, equipment, etc. The playout automation information 400 further includes a segment duration field 440, which indicates the time duration of a content segment. The playout automation information 400 includes other fields that may have meaning to the broadcasting company, advertisers, equipment, etc.

In the illustrated embodiments, the playout automation information 400 is formatted as an eXtensible Markup Language (XML) listing compliant to the Media Object Server (MOS) protocol. In other embodiments, the playout automation information, as well as the broadcast traffic information, may be formatted in XML and complying to MOS as well as in formats other than XML and complying to protocols other than MOS. Example formats and protocols for the playout automation information or the broadcast traffic information include Broadcast eXchange Format (BXF) (SMPTE-22), Asynchronous Messaging Protocol (AMP), Video Disk Control Protocol (VDCP), Video Tape Recorder (VTR) protocol, Generic Protocol Interface (GPI), Advanced Authoring Format (AAF), Simple Network Management Protocol (SNMP), the 9-pin protocol, and so on.

In one embodiment, the playout automation information is expanded with additional fields to add information to the playout automation information to be used in determining audio parameters for more specific altering of audio characteristics of content.

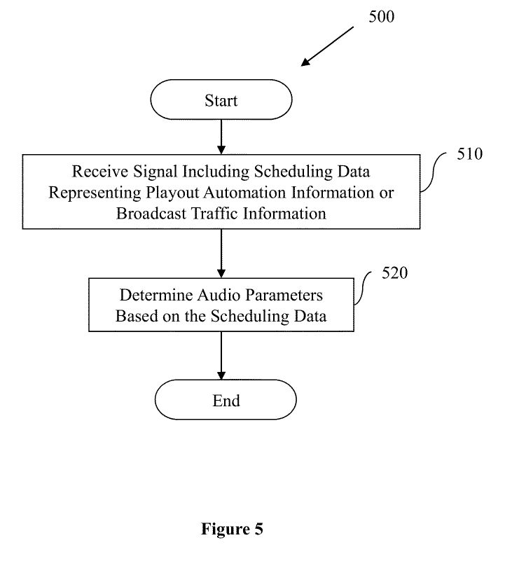

Example methods may be better appreciated with reference to the flow diagram of FIG. 5. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagram, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 5 illustrates a flow diagram for an example method 500 for automatic control of audio processing based on playout automation information or broadcast traffic information. At 510, the method 500 includes receiving an electronic signal including scheduling data representing at least one of playout automation information and broadcast traffic information. As discussed above, the scheduling data includes at least timing and content type information of content. In one embodiment, receiving the signal including scheduling data includes receiving the scheduling data substantially prior to airing of the content. In one embodiment, receiving the signal including scheduling data includes receiving the scheduling data just prior to airing of the content. In one embodiment, receiving the signal including scheduling data includes receiving the scheduling data substantially live as the content is about to air.

In one embodiment, the scheduling data is in a format (e.g., XML, MOS protocol, BXF, AMP, VDCP, VTR protocol, GPI, AAF, SNMP, 9-pin protocol, etc.) from which the playout automation information or the broadcast traffic information is extracted.

At 520, the method 500 further includes determining audio parameters for the processing of audio associated with the content based on the scheduling data. In one embodiment, determining audio parameters includes determining audio parameters for a portion of content scheduled to air just before or just after a transition from a first content type to a second content type.

In one embodiment, determining audio parameters includes determining dynamic range for at least one of the programming content and the advertising content to substantially reduce a difference in loudness between the programming content and the advertising content. In one embodiment, determining the dynamic range determines dynamic range only for portions of content scheduled to air immediately before or immediately after a transition from programming content to advertising content or from advertising content to programming content.

In one embodiment, the method includes receiving the audio associated with the content and altering the audio associated with the content based on the determined audio parameters. In one embodiment, the method includes transmitting the determined audio parameters to an audio processor for the audio processor to alter the audio associated with the content based on the audio parameters. In one embodiment, transmitting the determined audio parameters includes transmitting the determined audio parameters prior to airing or real time as the content is about to air.

In one embodiment, altering the audio associated with the content occurs substantially in real time as the content is about to air. In another embodiment, altering the audio associated with the content occurs substantially prior to airing.

While FIG. 5 illustrates various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other example methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted, or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A system for automatic control of audio processing based on at least one of playout automation information and broadcast traffic information, the system comprising:
a receiver configured to receive an electronic signal including scheduling data representing at least one of playout automation information and broadcast traffic information including at least timing and content type information of content, wherein the receiver is configured to receive the electronic signal including the scheduling data prior to airing of a content segment;
a content logic configured to determine audio parameters for the processing of audio associated with the content based on the scheduling data; and
a transmitter configured to transmit the determined audio parameters to an audio processor for the audio processor to dynamically alter the audio associated with the content based on the audio parameters.

2. The system of claim 1, further comprising:
a timing logic configured to determine a time for the audio processor to alter the audio associated with the content.

3. The system of claim 1, wherein the content includes multiple content types, and wherein the content logic is configured to determine audio parameters to alter dynamic range for at least a first content type content to substantially reduce a difference in loudness between the first content type content and a second content type content.

4. The system of claim 3, wherein the content logic determines parameters to alter dynamic range for portions of content scheduled to air immediately before or immediately after a transition from the first content type content to the second content type content such that audio during the transition transitions smoothly.

5. The system of claim 1, wherein the content logic is configured to determine audio parameters for at least one of:
a portion of content scheduled to air just before a transition from a first content type to a second content type, and
a portion of content scheduled to air just after a transition from a first content type to a second content type.

6. The system of claim 1, wherein the receiver is configured to receive the electronic signal including the scheduling data in a format from which the at least one of the playout automation information and the broadcast traffic information is extracted, wherein the format is at least one of:
eXtensible Markup Language (XML),
Broadcast eXchange Format (BXF),
Media Object Server (MOS) protocol,
Asynchronous Messaging Protocol (AMP),
Video Disk Control Protocol (VDCP),
Video Tape Recorder (VTR) protocol,
Generic Protocol Interface (GPI)
Advanced Authoring Format (AAF), and
Simple Network Management Protocol (SNMP).

7. A system for automatic control of audio processing based on at least one of playout automation information and broadcast traffic information, the system comprising:
a receiver configured to receive an electronic signal including scheduling data representing at least one of playout automation information and broadcast traffic information including at least timing and content type information of content; and
a content logic configured to determine audio parameters for the processing of audio associated with the content based on the scheduling data.

8. The system of claim 7, wherein the receiver is configured to receive the electronic signal including the scheduling data substantially prior to airing of the content.

9. The system of claim 7, comprising:
a transmitter configured to transmit the determined audio parameters to an audio processor for the audio processor to dynamically alter the audio associated with the content based on the audio parameters.

10. The system of claim 9, comprising:
a timing logic configured to determine a time for the audio processor to alter the audio associated with the content.

11. The system of claim 10, wherein the timing logic is configured to determine a time for the audio processor to alter the audio associated with the content substantially in real time as the content is about to air.

12. The system of claim 7, comprising:
an audio processor configured to alter the audio associated with the content based on the determined audio parameters.

13. The system of claim 7, wherein the content includes programming content and advertising content, and wherein the content logic is configured to determine audio parameters relating to dynamic range for at least one of the programming content and the advertising content to substantially reduce a difference in loudness between the programming content and the advertising content.

14. The system of claim 13, wherein the content logic determines audio parameters relating to dynamic range only for portions of content scheduled to air immediately before or immediately after a transition from programming content to advertising content or from advertising content to programming content.

15. The system of claim 7, wherein the content logic is configured to determine audio parameters for at least one of:
a portion of content scheduled to air just before a transition from a first content type to a second content type, and
a portion of content scheduled to air just after a transition from a first content type to a second content type.

16. A method for automatic control of audio processing based on at least one of playout automation information and broadcast traffic information, the method comprising:
receiving an electronic signal including scheduling data representing at least one of playout automation information and broadcast traffic information including at least timing and content type information of content; and
determining audio parameters for the processing of audio associated with the content based on the scheduling data.

17. The method of claim 16, comprising:
receiving the audio associated with the content; and
dynamically altering the audio associated with the content based on the determined audio parameters.

18. The method of claim 17, wherein altering the audio associated with the content occurs substantially in real time as the content is about to air.

19. The method of claim 17, wherein receiving the signal including scheduling data includes receiving the scheduling data substantially prior to airing of the content, and wherein altering the audio associated with the content includes altering the audio associated with the content at least one of:
substantially prior to airing, and
real time as the content is about to air.

20. The method of claim 16, comprising:
transmitting the determined audio parameters to an audio processor for the audio processor to alter the audio associated with the content based on the audio parameters.

21. The method of claim 20, wherein the receiving the signal including scheduling data includes receiving the signal including scheduling data substantially prior to airing of the content, and wherein the transmitting the determined audio parameters includes transmitting the determined audio parameters prior to airing or real time as the content is about to air.

22. The method of claim 16, wherein the content includes programming content and advertising content, and wherein determining audio parameters for the processing of the audio associated with the content based on the scheduling data includes determining audio parameters relating to dynamic range for at least one of the programming content and the advertising content to substantially reduce a difference in loudness between the programming content and the advertising content.

23. The method of claim 22, wherein determining the dynamic range determines dynamic range only for portions of content scheduled to air immediately before or immediately after a transition from programming content to advertising content or from advertising content to programming content.

24. The method of claim 16, wherein determining audio parameters for the processing of the audio associated with the content based on the scheduling data includes determining audio parameters for at least one of:
a portion of content scheduled to air just before a transition from a first content type to a second content type, and
a portion of content scheduled to air just after a transition from a first content type to a second content type.

25. The method of claim 16, wherein receiving playout automation information or broadcast traffic information includes receiving data in a format from which the at least one of the playout automation information and the broadcast traffic information is extracted, wherein the format is at least one of:
eXtensible Markup Language (XML),
Broadcast eXchange Format (BXF),
Media Object Server (MOS) protocol,
Asynchronous Messaging Protocol (AMP),
Video Disk Control Protocol (VDCP),
Video Tape Recorder (VTR) protocol,
Generic Protocol Interface (GPI)
Advanced Authoring Format (AAF), and
Simple Network Management Protocol (SNMP).
